(19) United States
(12) Patent Application Publication
(10) Pub. No.: US 2021/0207566 A1
(43) Pub. Date: Jul. 8, 2021

(54) FUEL INJECTION DEVICE

(71) Applicant: HITACHI AUTOMOTIVE SYSTEMS, LTD., Hitachinaka-shi, Ibaraki (JP)

(72) Inventors: Takatoshi IIZUKA, Hitachinaka-shi (JP); Kiyotaka OGURA, Hitachinaka-shi (JP); Takao MIYAKE, Hitachinaka-shi (JP); Masashi SUGAYA, Hitachinaka-shi (JP)

(73) Assignee: HITACHI AUTOMOTIVE SYSTEMS, LTD., Hitachinaka-shi, Ibaraki (JP)

(21) Appl. No.: 15/779,198

(22) PCT Filed: Jan. 23, 2017
(86) PCT No.: PCT/JP2017/002045

§ 371 Date: May 25, 2018

(30) Foreign Application Priority Data
Mar. 25, 2016 (JP) 2016-061081

(51) Int. Cl. F02M 51/06

(52) U.S. Cl. CPC F02M 51/0689

(57) ABSTRACT

Provided is a fuel injection device that sets an electromagnetic attraction force, which is generated in a magnetic gap between a magnetic core and a movable element, to more than or equal to a desired value. The fuel injection device includes a movable element that is attracted to the magnetic core and a housing provided opposite to the movable element in a direction orthogonal to an axial direction, wherein the movable element is configured so that an axial length of the movable element is 1.25 to 1.46 times as long as an axial length of the housing.

### TECHNICAL FIELD

The present invention relates to a fuel injection device used for an internal-combustion engine, particularly to a fuel injection device that performs fuel injection by opening and closing a fuel passage with the use of a movable element that is driven electromagnetically.

### BACKGROUND ART

One of the background arts in the present technical field is disclosed in JP 2012-188977 A. In this JP 2012-188977 A, an electromagnetic diaphragm with an inner diameter gradually increasing toward a movable element is provided on an inner peripheral surface of a magnetic core. This can reduce a magnetic delay time at a valve opening after current is supplied to an electromagnetic coil and before magnetic fluxes rise, and a magnetic delay time at a valve closing after current supply to the electromagnetic coil is stopped and before the magnetic fluxes rise; thus, the dynamic responsiveness at the valve opening and the valve closing can be improved (see Abstract).

### CITATION LIST

### Patent Literature

PTL 1: JP 2012-188977 A

### SUMMARY OF INVENTION

### Technical Problem

Engines for automobiles have recently been required to deal with stricter regulations on exhaust gas, higher fuel efficiency, and higher performance. In view of these, the fuel injection device as disclosed in PTL 1 needs atomization of spray and in this case, a fuel injection device capable of injection in a region filled with fuel having higher pressure will be required.

For example, in a case where the fuel injection device according to PTL 1 is attached to a common rail filled with the fuel having the high pressure, the high fuel pressure acts in a direction where a valve body to open and close a flow channel is closed. In this fuel injection device, magnetic fluxes are generated in a magnetic gap between the magnetic core and the movable element by supplying current in the electromagnetic coil, and thus an electromagnetic attraction force is generated. With the electromagnetic attraction force, the movable element is attracted to the magnetic core.

In this case, when the common rail is filled with the fuel with very high pressure, the conventional electromagnetic attraction force generated by the supply of current to the electromagnetic coil may fail to attract the movable element to the magnetic core and the valve opening may fail. When the electromagnetic attraction force is small, the valve opening speed of the valve body is slow; thus, in this case, the injection of desired minute fuel may fail.

In view of the above, it is an object of the present invention to provide a fuel injection device that sets the electromagnetic attraction force, which is generated in the magnetic gap between the magnetic core and the movable element, to more than or equal to a desired value.

### Solution to Problem

In order to solve the problems described above, a fuel injection device according to the present invention includes a movable element that is attracted to a magnetic core and a housing provided opposite to the movable element in a direction orthogonal to an axial direction, wherein the movable element is configured so that an axial length of the movable element is 1.25 to 1.46 times as long as an axial length of the housing.

### Advantageous Effects of Invention

By the above structure according to the present invention, a fuel injection device that sets the electromagnetic attraction force, which is generated in the magnetic gap between the magnetic core and the movable element, to more than or equal to a desired value can be provided. Other structure, operation, and effect of the present invention will be described in detail below in an example of the present invention.

### BRIEF DESCRIPTION OF DRAWINGS

FIG. 1 is a longitudinal cross-sectional view of a fuel injection device according to Example 1 of the present invention.

FIG. 2 is a magnified view of a driving unit structure of the fuel injection device according to Example 1 of the present invention in a valve closed state.

FIG. 3 is a magnified view of the driving unit structure of the fuel injection device according to Example 1 of the present invention in the valve closed state.

FIG. 4 is a magnified view of one side of the driving unit structure of the fuel injection device according to Example 1 of the present invention in the valve closed state.

FIG. 5 is a magnified view of a junction part between a nozzle holder and a magnetic core of the fuel injection device according to Example 1 of the present invention.

FIG. 6 is a graph expressing the relation between the ratio of an axial length of a movable element to an axial length of a housing of a fuel injection valve according to Example 1 of the present invention and a magnetic attraction force generated in the movable element.

FIG. 7 is a diagram expressing a magnetic flux density in a magnetic circuit of the fuel injection device according to Example 1 of the present invention.

FIG. 8 is a magnified view of the driving unit structure of the fuel injection device according to Example 1 of the present invention in a state that the movable element collides with a magnetic core.

FIG. 9 is a magnified view of the driving unit structure of the fuel injection device according to Example 1 of the present invention in a state that the movable element performs a valve closing movement.

FIG. 10 is a magnified view of a reference example of a driving unit structure of a fuel injection device.

FIG. 11 is a graph expressing the relation between a radial cross-sectional area of a housing and a radial cross-sectional area of an electromagnetic coil.

### DESCRIPTION OF EMBODIMENTS

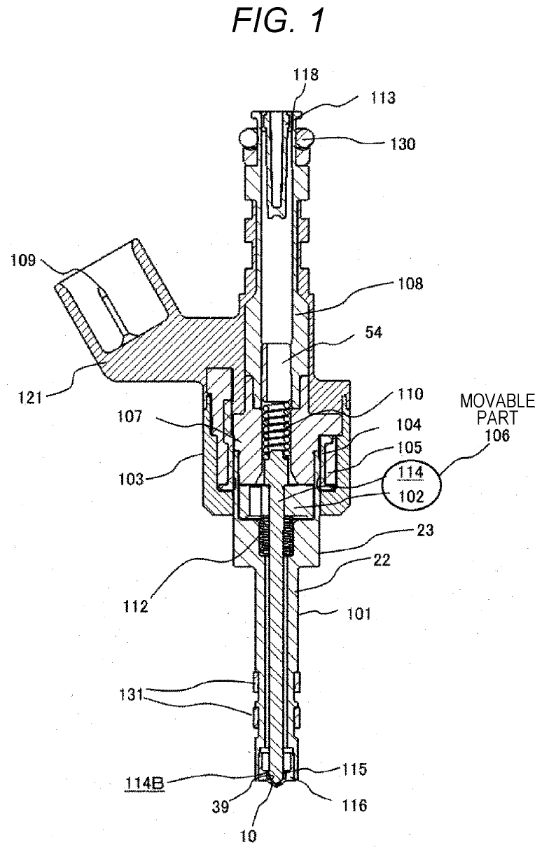

Examples of the present invention will hereinafter be described with reference to FIG. 1 to FIG. 11.

### EXAMPLES

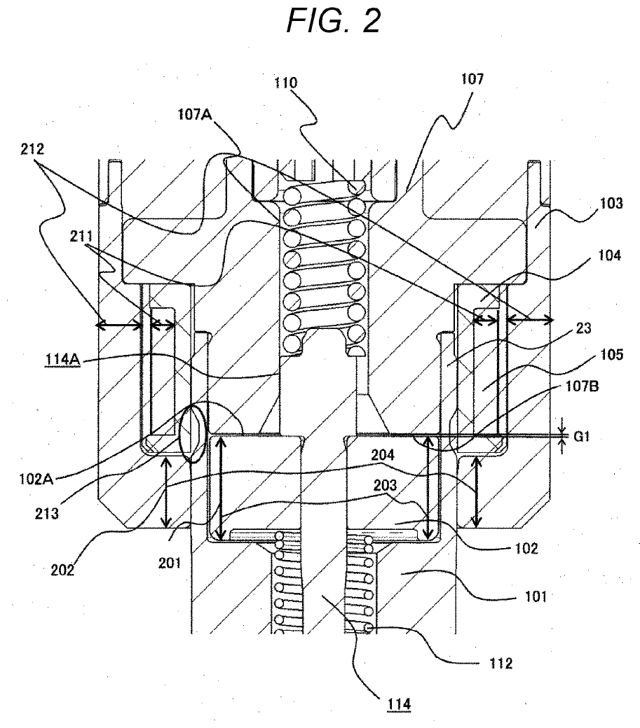

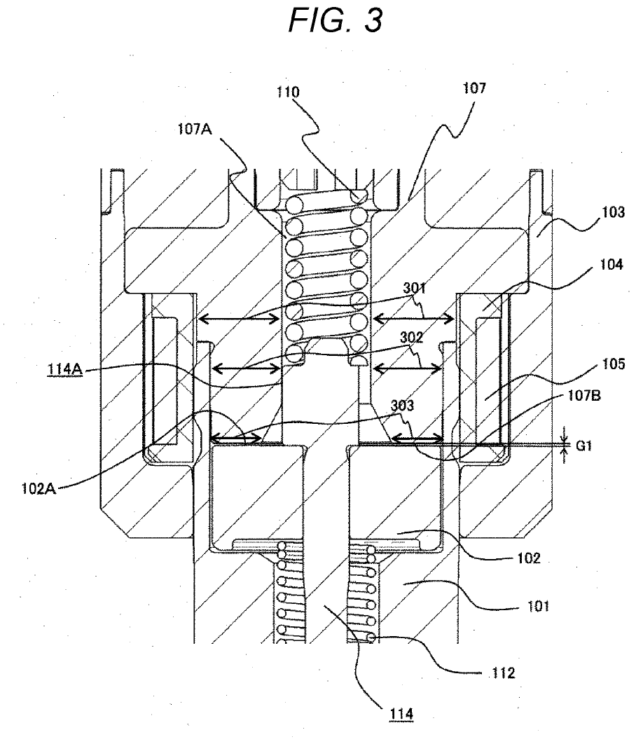

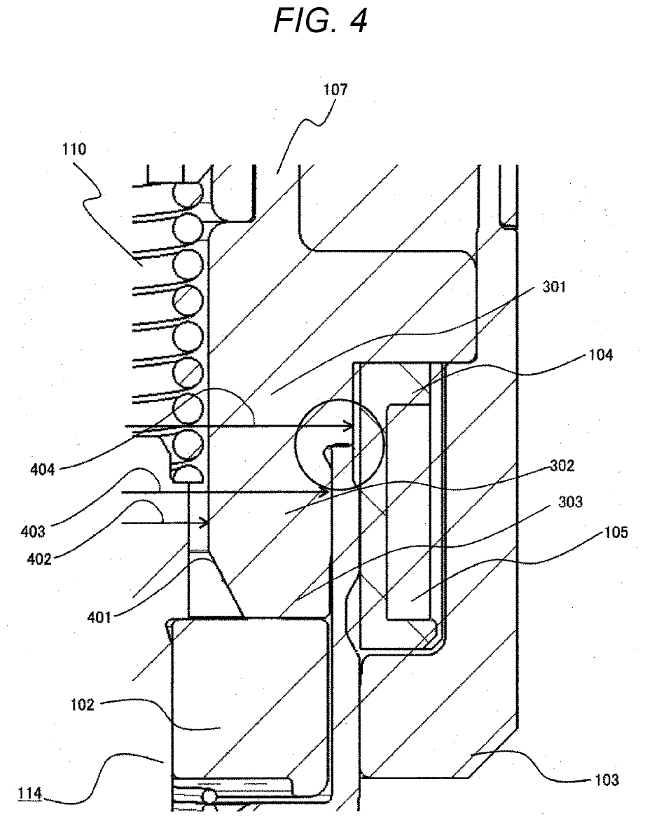

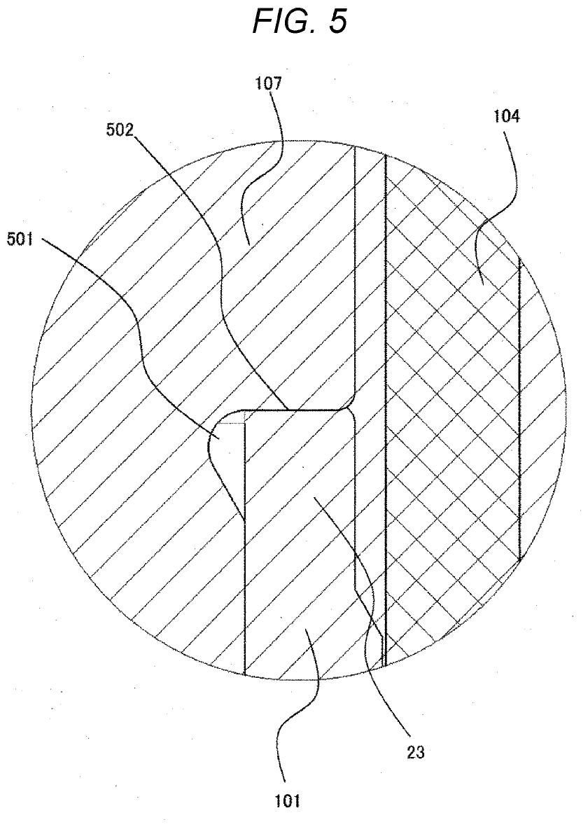

FIG. 1 is a diagram illustrating a basic structure of a fuel injection device according to Example 1 of the present invention. FIG. 2 and FIG. 3 are partially magnified views of a driving unit structure and its periphery that are illustrated in FIG. 1. FIG. 4 is a magnified view of one side of the driving unit structure and its periphery. FIG. 5 is a magnified view of a junction part in a magnetic circuit. FIG. 1 to FIG. 5 illustrate the details of the fuel injection device of the present example. With reference to FIG. 1 to FIG. 5, the structure and the basic operation of the fuel injection device are described. FIG. 1 to FIG. 5 illustrate a state in which current is not supplied to an electromagnetic driving unit (electromagnetic coil 105), the valve is closed, and the movable element remains stopped.

In the fuel injection device according to the present example, a valve body 114 is energized by a spring 110 to a valve closing direction. When current is not supplied to the electromagnetic coil 105, a fuel passage is closed. By supplying current to the electromagnetic coil 105, a movable element 102 is driven by an electromagnetic attraction force and the fuel passage is opened; thus, the fuel injection is performed.

The fuel injection device according to the present example forms the magnetic passage with a magnetic core 107, the movable element 102, a nozzle holder 101, and a housing 103. A diaphragm 213 is formed in a portion corresponding to a space between the magnetic core 107 and the movable element 102 in the nozzle holder 101. An electromagnetic coil 105 in a state of being wound around a bobbin 104 is attached to an outer peripheral side of the nozzle holder 101, and with a resin molded body 121, the insulating property is maintained.

As illustrated in FIG. 1, the nozzle holder 101 includes a small-diameter cylindrical portion 22 with small diameter and a large-diameter cylindrical portion 23 with large diameter. Inside an end part of the small-diameter cylindrical portion 22, a guide member 115 and an orifice cup 116 with a fuel injection port 10 are inserted. A guide member 115 is provided inside the orifice cup 116, and fixed by being press-fitted into or plastically coupled with the orifice cup 116, or is integrated with the orifice cup. The orifice cup 116 is welded to be fixed to the end part of the small-diameter cylindrical portion 22 along an outer peripheral part of an apical surface.

The guide member 115 guides an outer periphery 114B of the valve body provided at an end of the valve body 114 included in the movable part 106 to be described below. The orifice cup 116 is provided with a valve seat 39 having a circular conical shape on a side facing the guide member 115. With this valve seat 39, the valve body 114B provided at the end of the valve body 114 is in contact, and the flow of fuel is guided to the fuel injection port 10 or stopped. A groove is formed along an outer periphery of the nozzle holder 101, and in this groove, a sealing member 131 typified by a chip seal made of resin is fitted.

The magnetic core 107 is press-fitted into an inner peripheral part of the large-diameter cylindrical portion 23 of the nozzle holder 101, and is welded to be bonded at the press-fitting contact position. Thus, the space between the external air and the inside of the large-diameter cylindrical portion 23 is sealed. At a center of the magnetic core 107, a penetration hole (central hole) is provided, and the fuel is guided to the penetration hole. On a fuel supply port 118 side of the magnetic core 107, another member (adapter) 108 is press-fitted and welded to be bonded at the press-fitting contact position, and thus, the space between the external air and the inside is sealed. The inner diameter of the adapter 108 is provided with a penetration hole, which is similar to that of the magnetic core 107, and the penetration hole communicates with the fuel supply port 118.

The magnetic core 107 and the adapter 108 may be integrated to communicate with the fuel supply port 118 provided at an upper end part of the fuel injection device (at an end part opposite to the fuel injection port 10). Inside the fuel supply port 118, a filter 113 is provided. On the outer peripheral side of the fuel supply port 118, a sealing material 130 is provided to keep the liquid tightness between the fuel supply port 118 and a connector on a fuel pipe side.

FIG. 1 illustrates a normal state in which current is not supplied to the electromagnetic coil 105, and in this state, the valve body 114 is energized to a valve closing direction by the spring 110. Therefore, the seat part 114B of the valve body 114 is in contact with the valve seat 39 of the orifice cup on the downstream side of the nozzle holder, and the fuel is sealed. Here, the movable element 102 is supported by the valve body 114, and is energized to the valve opening direction by a zero spring 112 that is supported by the nozzle holder between the nozzle holder 101 and the movable element 102.

Next, with reference to FIG. 2 to FIG. 5, a structure of the driving unit in a state that current is supplied to the fuel injection device and the movable element 102 collies with the valve body 114 is described. When current is supplied to the electromagnetic coil 105, magnetic fluxes are generated in the magnetic passage, and the magnetic attraction force is generated between the magnetic core 107 and the movable element 102 corresponding to the movable member. In the fuel injection valve according to the present example, by supplying current to the electromagnetic coil 105, the magnetic fluxes are generated in the magnetic circuit including the magnetic core 107, the movable element 102, the nozzle holder 101 and the housing 103, and the magnetic attraction force is generated between the magnetic core 107 and the movable element 102. The magnetic fluxes passing the magnetic core 107 are distributed to magnetic fluxes flowing toward the nozzle holder 101 side at a position of an end surface of the magnetic core 107 on the movable element 102 side and magnetic fluxes flowing toward an attraction surface side of the magnetic core 107, that is, toward a magnetic gap side between the magnetic core 107 and the movable element 102. At this time, the magnetic attraction force is determined based on the magnetic flux density and the number of magnetic fluxes passing between the magnetic core 107 and the movable element 102.

Next, a structure of the movable part 106 is described with reference to FIG. 2 that is a magnified view of the driving unit structure of the fuel injection device in a valve closed state. As described above, the magnetic core 107 is press-fitted to the inner peripheral part of the large-diameter cylindrical portion 23 of the nozzle holder 101, and welded to be bonded at the press-fitting contact position. Here, the movable element 102 is incorporated in the large-diameter cylindrical portion 23 of the nozzle holder 101. In a normal state in which the current is not supplied to the fuel injection device, the movable element 102 is energized to the magnetic core 107 side by the energizing force of the zero spring 112. The magnetic core 107 is a component that operates the magnetic attraction force to the movable element 102 to attract the movable element 102 to the valve opening direction. A lower end surface (collision surface) 107B of the magnetic core 107 and an upper end surface (collision surface) 102B of the movable element 102 may be plated as necessary to improve the durability. If the movable element 102 and the magnetic core 107 are formed of soft magnetic stainless steel that is relatively soft, the durability and the reliability can be maintained by using hard chromium plating or electroless nickel plating.

A penetration hole 107A provided as the fuel passage at a center of the magnetic core 107 has a diameter that is a little larger than the diameter of a slidable part 114A of the valve body 114. With a spring receiving surface provided at an upper end surface of the valve body 114, a lower end of the spring 110 for initial load setting is in contact. The other end of the spring 110 is received by an adjustment element 54 press-fitted into an inside of a penetration hole 108A of the adapter 108. The spring 110 is fixed between the valve body 114 and the adjustment element, and by adjusting the fixing position of the adjustment element 54, the initial load for the spring 110 to press the valve body 114 against the valve seat 39 can be adjusted.

The movable element 102 is set in the large-diameter cylindrical portion 23 of the nozzle holder 101, and the housing 103 and the electromagnetic coil 105 wound around the bobbin 104 are mounted at an outer periphery of the large-diameter cylindrical portion 23 of the nozzle holder 101. After that, the valve body 114 is provided to penetrate the movable element 102 through the penetration hole 108A of the adapter 108 and the penetration hole 107A of the fixing core 107. In this state, the valve body 114 is pressed down to the valve closing position by a jig, and by determining the press-fitting position of the orifice cup 116 while detecting the stroke of the valve body 114 when the current is supplied to the electromagnetic coil 105, the stroke of the movable part 106 is adjusted to an arbitrary position.

In a state in which the initial load of the spring 110 is adjusted, the lower end surface 107B of the magnetic core 107 faces the upper end surface 102A of the movable element 102 of the movable part 106 with a stroke G1 of approximately 40 to 100 micrometers.

Along the outer periphery of the large-diameter cylindrical portion 23 of the nozzle holder 101, the housing 103 with a cup-like shape is fixed. At a center of a bottom of the housing 103, a penetration hole is provided, and through this penetration hole, the large-diameter cylindrical portion 23 of the nozzle holder 101 is inserted. An outer peripheral wall of the housing 103 constitutes an outer peripheral yoke part that faces an outer peripheral surface of the large-diameter cylindrical portion 23 of the nozzle holder 101.

Inside a cylindrical space formed by the housing 103, the electromagnetic coil 105 with an annular or cylindrical shape is disposed. The electromagnetic coil 105 includes the bobbin 104 with an annular shape having a groove whose cross section has a U-like shape and which opens to the outside in a radial direction, and a copper wire (electromagnetic coil 105) wound in the groove. A conductor with rigidity is fixed to an end part where the electromagnetic coil 105 starts to wind and an end part where the electromagnetic coil 105 ends to wind, and the conductor is led out from the penetration hole provided to the magnetic core 107. At the outer periphery of the large-diameter cylindrical portion 23 of the nozzle holder 101, the magnetic core 107, and the conductor 109, insulated resin is injected from an inner periphery of an upper end opening of the housing 103 and molded; thus, those are covered with the resin molded body 121. A magnetic passage with an annular shape is formed in a portion of the magnetic core 107, the movable element 102, the large-diameter cylindrical portion 23 of the nozzle holder 101, and the housing 103 so as to surround the electromagnetic coil 105.

Although not shown here, the fuel injection device according to the present example is attached to a common rail to which high-pressure fuel is supplied from a high-pressure fuel pump, and the fuel with the high pressure is directly injected into the cylinder of the internal-combustion engine. To deal with the recent stricter regulations on exhaust gas and the demand for higher fuel efficiency, the fuel pressure of the common rail has become as high as 20 MPa or more. The fuel pressure is expected to increase further in the future and a fuel injection device capable of stable fuel injection even in such a case is required.

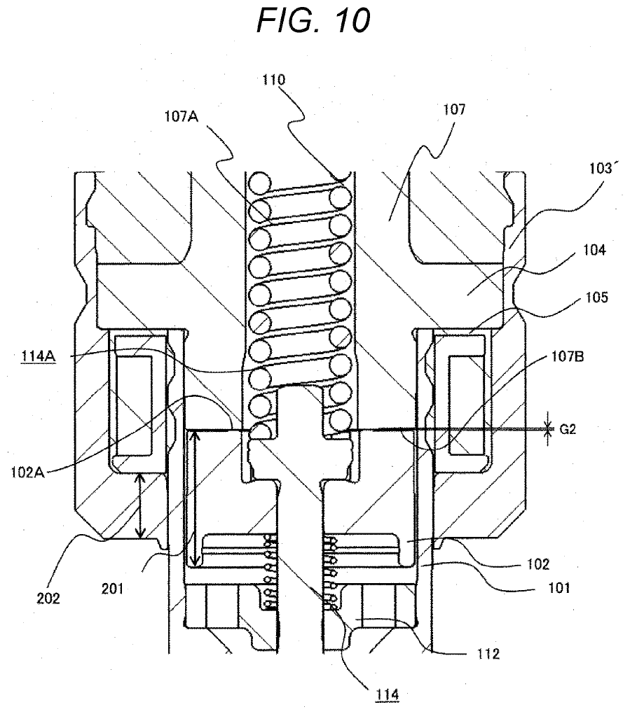

For example, it is assumed that the fuel pressure of the common rail is 35 MPa in the structure illustrated in FIG. 10. In FIG. 10, an axial length 201 of the movable element 102 of the fuel injection device is 2.1 times as long as an axial length 202 of the housing 103 on an opposite side across the nozzle holder 101.

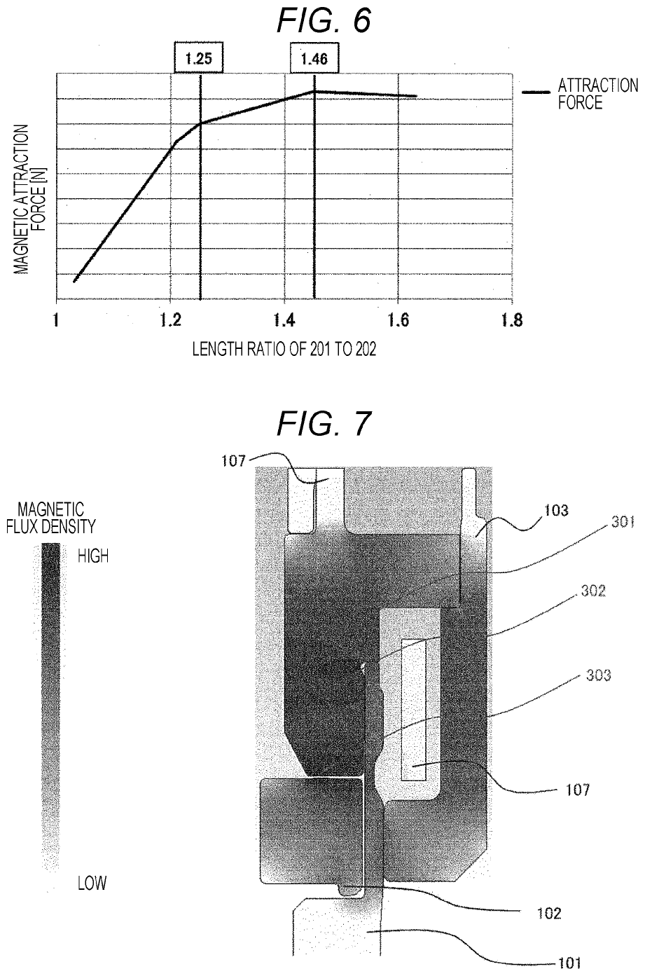

Here, FIG. 6 shows the relation between the ratio of the axial length 201 of the movable element to the axial length 202 of the housing 103, and the magnetic attraction force generated in the movable element 102. However, in the structure of FIG. 10, assuming that the magnetic attraction force desired in the present example as illustrated in FIG. 6 is 80 N, this magnetic attraction force cannot be obtained even if a current of 20 A or more is applied. That is to say, the valve opening may fail because of a lack of the magnetic attraction force. Therefore, even if the valve opening is possible, the valve opening speed is slow so that the fuel injection with the minimum necessary amount may fail.

In view of the above, in the present example, as illustrated in FIG. 2, the axial length 201 of the movable element 102 of the fuel injection device according to the present example is set 1.25 to 1.46 times as long as the axial length 202 of the housing 103 on the opposite side across the nozzle holder 101. That is to say, the fuel injection device includes the movable element 102 that is attracted to the magnetic core 107, and the housing 103 disposed opposite to the movable element 102 in a direction orthogonal to the axial direction, and the movable element 102 and the housing 103 are configured so that the axial length 201 of the movable element 102 is 1.25 to 1.46 times as long as the axial length 202 of the housing 103.

By making the axial length 201 of the movable element 102 more than or equal to 1.25 times as long as the axial length 202 of the housing 103, the cross-sectional area of the movable element 102 in the magnetic circuit can be secured. Since this can reduce the magnetic resistance, the magnetic attraction force generated in the movable element 102 can be improved and the desired magnetic attraction force of 80 N can be secured by the application of a current of 19 A as shown in FIG. 6.

As shown in FIG. 6, the magnetic attraction force tends not to increase when the axial length 201 of the movable element 102 is more than or equal to 1.46 times as long as the axial length 202 of the housing 103. Furthermore, as the axial length 201 of the movable element 102 is increased, the mass of the movable element 102 is increased. Since the increase in mass of the movable element 102 leads to the deterioration in responsiveness of the movable element 102, it is desirable that the axial length 201 of the movable element 102 is less than or equal to 1.46 times as long as the axial length 202 of the housing 103.

Therefore, by configuring the movable element 102 so that the axial length 201 of the movable element 102 is 1.25 to 1.46 times as long as the axial length 202 of the housing 103, the magnetic attraction force generated in the movable element 102 can be increased efficiently.

Furthermore, as illustrated in FIG. 2, it is desirable that an outer peripheral side entire area 203 of the movable element 102 of the fuel injection device according to the present example is 0.9 to 1.1 times as large as an axial entire cross-sectional area 204 of the housing 103 on an opposite side across the large-diameter cylindrical portion 23 of the nozzle holder 101.

When the outer peripheral side entire area 203 of the movable element 102 is more than or equal to 0.9 times as large as the axial entire cross-sectional area 204 of the housing 103, the magnetic resistance can be reduced and the magnetic attraction force generated in the movable element 102 can be secured. In addition, when the outer peripheral side entire area 203 of the movable element 102 is less than or equal to 1.1 times corresponding to a section where the magnetic attraction force tends to increase, the magnetic attraction force generated in the movable element 102 can be increased efficiently even with a smaller magnetomotive force than the conventional magnetomotive force.

Furthermore, as illustrated in FIG. 2, when a radial cross-sectional area 212 of the housing 103 and a radial cross-sectional area 211 of the electromagnetic coil 105 are compared, it is desirable that the radial cross-sectional area 212 of the housing 103 is more than or equal to twice as large as the radial cross-sectional area 211 of the electromagnetic coil 105.

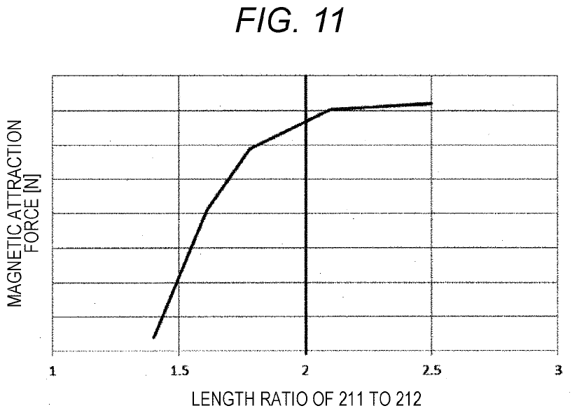

In FIG. 11, the horizontal axis represents the comparison between the radial cross-sectional area 212 of the housing 103 and the radial cross-sectional area 211 of the electromagnetic coil 105, and the vertical axis represents the magnetic attraction force in that case. The increase in magnetic attraction force tends to become dull after the length ratio becomes twice or more. Thus, by making the radial cross-sectional area of the housing 103 twice or more, the magnetic resistance in the housing 103 can be reduced and the magnetic attraction force generated between the magnetic core and the movable element 102 can be increased.

It is desirable that the cross-sectional area of a surface of the magnetic core 107 as the magnetic passage of the fuel injection device according to the present example, which is perpendicular to the axial direction of the valve body 114, decreases from the upstream side to the collision surface and abuts on the nozzle holder 101 in a portion where the cross-sectional area is the largest.

In the present example, as illustrated in FIG. 3, the magnetic core 107 includes, at positions in the axial direction in accordance with the electromagnetic coil 105, from the upper side, a first portion 301 with a first horizontal cross-sectional area (large-diameter portion), a second portion 302 with a second horizontal cross-sectional area (medium-diameter portion), and a third portion 303 with a third horizontal cross-sectional area (small-diameter portion). The cross-sectional area of the first portion 301 (large-diameter portion) at the top is larger than the cross-sectional area of the second portion 302 (medium-diameter portion), and the cross-sectional area of the third portion 303 (small-diameter portion) is smaller than the cross-sectional area of the second portion 302 (medium-diameter portion).

In FIG. 7, the distribution of the magnetic flux density in the magnetic circuit according to the present example is shown by color gradation. Note that other components than the magnetic core 107 of the magnetic circuit, the housing 103, the nozzle holder 101, the movable element 102, and the electromagnetic coil 105 are not shown.

In the above structure, the distribution of the magnetic flux density in the magnetic core 107 is the highest in the third portion 303 (small-diameter portion), the second highest in the second portion 302 (medium-diameter portion), and the lowest in the first portion 301 (large-diameter portion). Therefore, the magnetic resistance except in the attraction surface can be reduced, the magnetic flux density can be reduced, and the diaphragm of the cross-sectional area to the attraction surface can promote the increase in magnetic flux density at the attraction surface, and the magnetic attraction force can be increased efficiently. As a result, the larger magnetic attraction force than the conventional magnetic attraction force can be obtained.

As illustrated in FIG. 3, the magnetic core 107 of the fuel injection device according to the present example is configured so that the third portion 303 (small-diameter portion) has an outer peripheral surface formed at the same position as an outer peripheral surface 403 of the second portion 302 (medium-diameter portion), and an inner peripheral surface 401 of the third portion 303 (small-diameter portion) is formed to expand to an inner peripheral surface 402 of the second portion 302 (medium-diameter portion) toward the inner peripheral side. In other words, the magnetic core 107 is formed to have a gradually smaller diameter from the end surface on the movable element side toward the upstream side in the fuel flowing direction, and this inner diameter portion 401 has, for example, a tapered surface.

With this feature, the effect of increasing the magnetic flux density of the attraction surface of the movable element 102 can be easily obtained by the diaphragm of the cross-sectional area to the attraction surface. As shown in FIG. 7, the magnetic attraction force of the third portion 303 (small-diameter portion) can be improved as compared to the magnetic flux density of the second portion 302 (medium-diameter portion). In addition, an inner-diameter expansion part provided to the magnetic core 107 is formed so that the inner diameter expands in a downstream direction; therefore, a fluid channel can be secured between the magnetic core 107 and the valve body. In a case where the fluid channel is deficient, a diaphragm is formed when the fluid passes the magnetic core 107 and the valve body, and the pressure loss increases. As a result, the maximum flow rate capable of injection decreases and it becomes difficult to inject the desired fuel.

It is desirable to configure the magnetic core 107 so that the inner peripheral surface 402 of the second portion 302 (medium-diameter portion) is formed at the same position as the inner peripheral surface of the first portion 301 (large-diameter portion) and an outer peripheral surface 404 of the first portion 301 (large-diameter portion) is formed to expand to the outer peripheral side more than the outer peripheral surface 403 of the second portion 302 (medium-diameter portion).

In this manner, by increasing the area of the portion of the magnetic core where the magnetic fluxes pass except in the attraction surface of the movable element 102, as illustrated in FIG. 7, the distribution of the magnetic flux density in the magnetic core 107 is the highest in the third portion 303 (small-diameter portion), the second highest in the second portion 302 (medium-diameter portion), and the lowest in the first portion 301 (large-diameter portion). Therefore, the magnetic resistance except in the attraction surface of the magnetic core 107 can be reduced and the magnetic flux density except in the attraction surface can be reduced, and the magnetic attraction force can be increased efficiently.

As illustrated in FIG. 5, in the present example, the first portion 301 (large-diameter portion) of the magnetic core 107 expands to the outer peripheral side of the second portion 302 (medium-diameter portion), and the large-diameter cylindrical portion 23 of the nozzle holder 101 covering the outer peripheral side of the movable element 102 abuts on an outer periphery expansion part 502 of the first portion 301 (large-diameter portion) of the magnetic core 107 so as to be fixed.

Here, from the aspect of the structure of the fuel injection valve, it is necessary that the movable element 102 and the magnetic core 107 to generate the magnetic attraction force secure the attraction area as large as possible. Therefore, the nozzle holder 101 is desirable to be thin. On the contrary, it is necessary to secure the strength for the high fuel pressure; thus, the nozzle holder 101 is formed of a material with high strength. However, since a material with high strength generally has a low magnetic property; therefore, the nozzle holder 101 needs to be formed of the material with a low magnetic property. In view of this, in the magnetic core 107, the first portion 301 (large-diameter portion) is expanded to the outer peripheral side of the second portion 302 (small-diameter portion) to abut on the nozzle holder. This enables the magnetic core 107 with the excellent magnetic property in the magnetic passage to have a larger cross-sectional area and to reduce the magnetic resistance of an upstream part of the magnetic core 107. As a result, the magnetic attraction force can be improved.

As illustrated in FIG. 3, the cross-sectional area of the third portion 303 (small-diameter portion) is formed to be 0.78 to 0.85 times as large as the cross-sectional area of the second portion 302 (medium-diameter portion). Thus, as is shown in FIG. 7, it is understood that the magnetic flux density of the attraction surface of the third portion 303 (small-diameter portion) and the movable element 102 opposite to the third portion 303 becomes high. Therefore, the magnetic flux density of the attraction surface can be increased while the cross-sectional area of the attraction surface of the magnetic core 107 is secured, and the magnetic attraction force can be improved.

As illustrated in FIG. 5, an escape portion 501 may be formed from the first portion 301 (large-diameter portion) to the second portion 302 (medium-diameter portion) of the magnetic core 107, and the escape portion 501 is used when the nozzle holder 101 is press-fitted. In a case of assembling the nozzle holder 101 and the magnetic core 107 by a method of press-fitting or the like, an upper end surface of the nozzle holder 101 and a corner part of the magnetic core 107 may be rounded due to the processing; therefore, an escape portion needs to be formed in a contact part. By providing the escape portion 501 not to the nozzle holder 101 but to the magnetic core 107, the area to receive the load generated in the press-fitting can be secured and the strength can be secured.

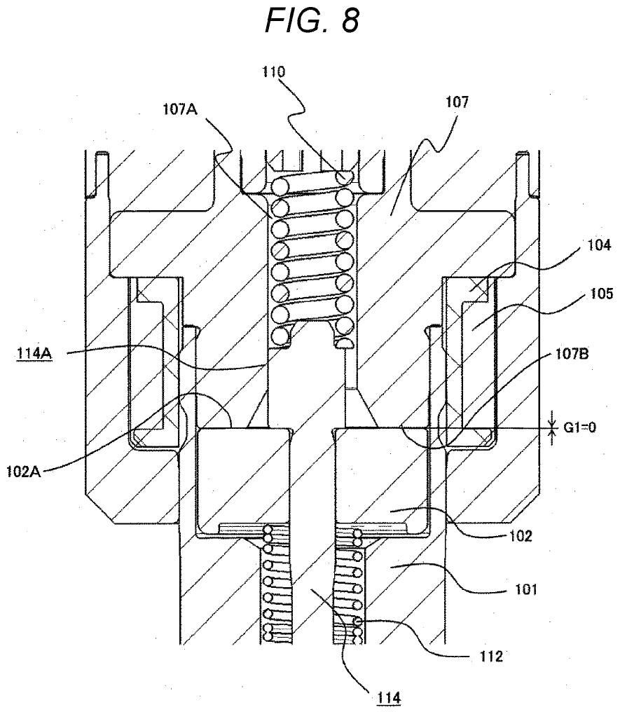

FIG. 8 illustrates a state in which the movable element 102 is attracted due to the magnetic attraction force and the movable element 102 collides with the lower surface 107B of the magnetic core 107. When current is supplied to the electromagnetic coil 105, magnetization of the movable element 102 progresses from the inside to the outside of the electromagnetic coil 105, that is, from the outer peripheral side to the inner peripheral side of the magnetic core 107 due to the influence of an eddy current. When the magnetic attraction force generated by the current exceeds the sum of the load by the spring 110 and the force acting on the valve body 114 by the fuel pressure, the movable element 102 starts to move upward.

At this time, the valve body 114 moves upward together with the movable element 102 until the upper end surface of the movable element 102 collides with the lower surface 107B of the magnetic core 107 (G1=0). As a result, the seat part 114B of the valve body 114 is separated from the valve seat 39 of the orifice cup 116, and the supplied fuel is injected from a plurality of injection holes. The number of injection holes may be one.

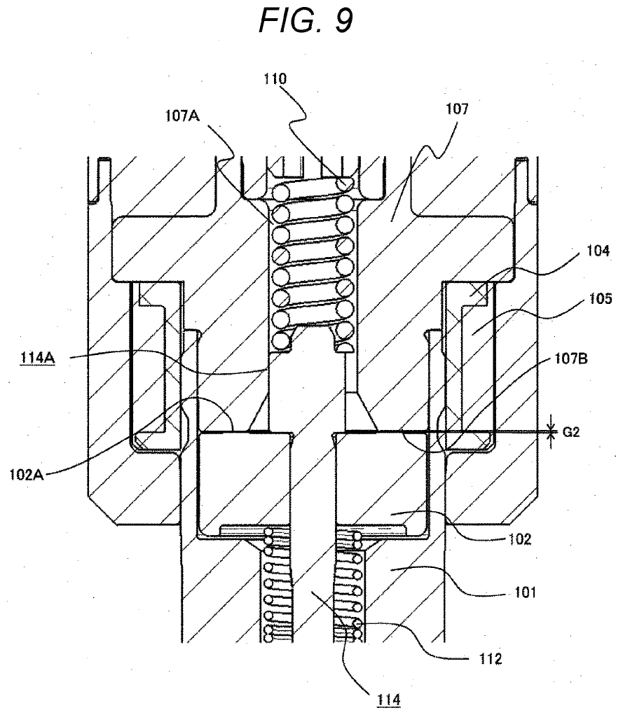

With reference to FIG. 9, a structure of the driving unit in a state that current supply to the fuel injection device is stopped and the seat part 114B of the valve body 114 is in the valve seat 39 is described. When the current supply to the electromagnetic coil 105 is stopped and the magnetic attraction force acting between an anchor 102 and the fixing core 107 becomes smaller than the energizing force of the first spring, the movable part 106 starts to move toward the valve closing direction. However, the eddy current is generated in the magnetic passage in a direction opposite to a direction in which the magnetic fluxes are cancelled even after the current supply to the coil 105 is stopped; thus, there is a magnetic delay after the current supply to the electromagnetic coil is stopped and before the magnetic fluxes decrease and the attraction force decreases. After the magnetic delay, the magnetic fluxes in the magnetic passage are lost and the magnetic attraction force is also lost. As the magnetic attraction force that acts on the movable element 102 is lost, the valve body 114 is returned to the closing position where the valve body 114 is in contact with the valve seat 39 by the load of the spring 110 and the force by the fuel pressure. FIG. 5 illustrates a state in which the movable part 106 in the valve opened state starts the valve closing movement, and a gap as indicated by G2 is formed between the movable element and the magnetic core 107. After the stroke G2 in the valve closing operation has moved by a desired stroke (G2=G1), the valve body 114 comes to the valve closing position where the valve body 114 is in contact with the valve seat 39, and thus the fuel injection ends.

Note that it is desirable that the fuel injection device according to the present example is used particularly for a supercharger-attached type in which a fuel is directly injected to an engine. The supercharger-attached type is desirable because the recent engine is required to have smaller size.

### REFERENCE SIGNS LIST

10 fuel injection port
22 small-diameter cylindrical portion
23 large-diameter cylindrical portion
39 valve seat
54 adjustment element
101 nozzle holder
102 anchor
102A upper end surface of anchor 102
103 housing
104 bobbin
105 electromagnetic coil
106 movable part
107 magnetic core
107B lower end surface of magnetic core 107
107A inner peripheral surface (penetration hole) of magnetic core
107
108 adapter
109 conductor
110 spring
112 zero spring
113 filter
114 valve body
114A slidable part of valve body
114B seat part of valve body
118 fuel supply port
121 resin molded body
130 sealing material
131 sealing member
201 axial length of movable element
202 axial length of housing
203 movable element side area
204 axial cross-sectional area of housing
211 radial cross-sectional area of electromagnetic coil
212 radial cross-sectional area of housing
213 diaphragm
301 first portion of magnetic core (large-diameter portion)
302 second portion of magnetic core (medium-diameter portion)
303 third portion of magnetic core (small-diameter portion)
401 inclined portion from third portion to second portion of magnetic core
402 inner peripheral surface of first portion and second portion of magnetic core
403 outer peripheral surface of second portion of magnetic core
404 outer peripheral surface of first portion of magnetic core
501 escape of press-fitted portion
502 junction surface of magnetic core and nozzle holder
G1 stroke in valve closed state
G2 stroke in valve closing operation

1. A fuel injection device comprising a movable element that is attracted to a magnetic core and a housing provided opposite to the movable element in a direction orthogonal to an axial direction, wherein
the movable element is configured so that an axial length of the movable element is 1.25 to 1.46 times as long as an axial length of the housing.

2. The fuel injection device according to claim 1, wherein the movable element is configured so that a side area of the movable element is 0.9 to 1.1 times as large as an axial cross-sectional area of the magnetic part.

3. The fuel injection device according to claim 1, further comprising a coil provided inside the magnetic part, wherein a lower surface of the magnetic core that collides with the movable element is disposed at a position corresponding to a lower end of the coil or disposed below the position corresponding to the lower end of the coil.

4. The fuel injection device according to claim 1, wherein
the housing is configured so that a radial cross-sectional area of the housing is more than or equal to twice as large as a radial cross-sectional area of an electromagnetic coil incorporated in the housing.

5. A fuel injection device comprising a movable element that is attracted to a magnetic core and a magnetic part provided opposite to the movable element in an axial direction, wherein
the magnetic core includes, at positions in the axial direction in accordance with the electromagnetic coil, from an upper side, a first portion with a first horizontal cross-sectional area, a second portion with a second horizontal cross-sectional area, and a third portion with a third horizontal cross-sectional area, the cross-sectional area of the first portion is larger than the cross-sectional area of the second portion, and the cross-sectional area of the third portion is smaller than the cross-sectional area of the second portion.

6. The fuel injection device according to claim 5, wherein
the magnetic core is formed so that an outer peripheral surface of the third portion is formed at the same position as an outer peripheral surface of the second portion and the magnetic core expands toward an inner peripheral side from an inner peripheral surface of the third portion to an inner peripheral surface of the second portion.

7. The fuel injection device according to claim 6, wherein
the magnetic core is formed so that the inner peripheral surface of the second portion is formed at the same position as an inner peripheral surface of the first portion, and the magnetic core expands toward an outer peripheral side from the outer peripheral surface of the second portion to an outer peripheral surface of the first portion.

8. The fuel injection device according to claim 5, wherein
the magnetic core is formed to expand toward an outer peripheral side from an outer peripheral surface of the second portion to an outer peripheral surface of the first portion and a nozzle covering an outer peripheral side of the movable element abuts on an expansion part of the first portion to an outer periphery so as to be fixed.

9. The fuel injection device according to claim 1, wherein
the cross-sectional area of the third portion is 0.78 to 0.85 times as large as the cross-sectional area of the second portion.

10. The fuel injection device according to claim 1, wherein an inner diameter of the magnetic core is inclined to an outer peripheral side toward a collision surface with the movable element.

11. The fuel injection device according to claim 5, wherein
the cross-sectional area of the third portion is 0.78 to 0.85 times as large as the cross-sectional area of the second portion.
